(19) United States
(12) Patent Application Publication
(10) Pub. No.: US 2019/0064324 A1
(43) Pub. Date: Feb. 28, 2019

(54) LASER RADAR PROJECTOR

(71) Applicant: FARO Technologies, Inc., Lake Mary, FL (US)

(72) Inventors: Steven Paul Kaufman, Hooksett, NH (US); Kari J. Mettinen, Tilton, NH (US); Masoud Mohazzab, Andover, MA (US); Arkady Savikovsky, Burlington, MA (US); Joel H. Stave, New Boston, NH (US)

(21) Appl. No.: 16/102,083

(22) Filed: Aug. 13, 2018

Related U.S. Application Data
(60) Provisional application No. 62/550,099, filed on Aug. 25, 2017.

(51) Int. Cl. G01S 7/481; G02F 1/11; G01S 17/42

(52) U.S. Cl. CPC G01S 7/4814; G02F 1/113; G01S 17/42; G02B 27/108; G02F 2201/02; G02F 2201/34; G01S 7/4817

(57) ABSTRACT

A laser radar projection system is provided. The system includes a laser projector that projects a light beam. A beam splitter is arranged to receive the light beam from the projector and divides the light beam into a signal light beam and a reference light beam. A steering system changes the direction of the signal light beam and scans the light beam over at least a portion of the surface. An optical signal detector is arranged to receive a feedback light beam and the reference light beam. The optical signal detector generates a feedback signal in response to the feedback light beam and a reference signal in response to the reference light beam. One or more processors determine the distance to one or more points on the at least a portion of the surface based at least in part on the feedback signal and the reference signal.

### CROSS REFERENCE TO RELATED APPLICATIONS

This application claims the benefit of U.S. Provisional Application Ser. No. 62/550,099, filed Aug. 25, 2017, the entire disclosure of which is incorporated herein by reference.

### BACKGROUND

The subject matter disclosed herein relates to a laser radar projector, and in particular to a laser radar projector with a reference channel having about the same optical power as the measurement channel.

Many of today's advanced production processes require in-line quality control and in-process verification. This is especially important, for example, in aircraft manufacturing, where most of assembly operations are manual. In these types of applications, one hundred percent quality assurance is often desired. Hence, in-process measurement of 3-dimensional structures, parts, and assemblies is frequently used for validation. In a number of applications, especially involving composite materials, the non-contact methods are used for inspection purposes.

Further, laser systems commonly referred to as laser projectors are also widely used in contemporary manufacturing. Laser scanning technique in the form of laser projection is often utilized in production processes as a templating method in manufacturing of composite parts, in aircraft and marine industries or other large machinery assembly processes, truss building, painting, and other applications. It gives the user ability to eliminate expensive hard tools, jigs, templates, and fixtures. Laser projectors utilize computer-assisted design (CAD) data to generate glowing templates on a 3D object surface. Glowing templates generated by laser projection are used in production assembly processes to assist in the precise positioning of parts, components, and the like on any flat or curvilinear surfaces. Laser projection technology brings flexibility and full CAD compatibility into the assembly process. In the laser assisted assembly operation, a user positions component parts by aligning some features (edges, corners, etc.) of a part with the glowing template. After the part positioning is completed, the user fixes the part with respect to the article being assembled. However, the accuracy of laser projection, and, consequently, of the assembly process, is only adequate if the object is built exactly up to its CAD model. This is not the case for all applications, and as such there are a number of non-trivial issues associated with such applications. The combination of the laser projector with laser light detection and ranging (“LIDAR”) provides a system that performs both placement and verifying functions.

Accordingly, while existing laser radar projectors are suitable for their intended purposes the need for improvement remains, particularly in providing a laser radar projector having features described herein.

### BRIEF DESCRIPTION

According to one aspect of the disclosure a laser radar projection system is provided. The laser radar projection system includes a laser projector that projects a light beam. A beam splitter is arranged to receive the light beam from the laser projector, wherein in operation the beam splitter divides the light beam into a signal light beam and a reference light beam. A steering system is provided that in operation changes the direction of the signal light beam onto the surface of an object and in operation scan the light beam over at least a portion of the surface, wherein the projected light beam is diffusely reflected from the surface as a feedback light beam. An optical signal detector is arranged to receive the feedback light beam and the reference light beam, the optical signal detector generating a feedback signal in response to receiving the feedback light beam and a reference signal in response to receiving the reference light beam. One or more processors that are responsive to executable computer instructions are provided for determining the distance to one or more points on the at least a portion of the surface based at least in part on the feedback signal and the reference signal.

According to another aspect of the disclosure a method of determining three-dimensional coordinates of at least one point on a surface of an object is provided. The method includes emitting a beam of light from a laser projector. The beam of light is divided with a beam splitter into a signal light beam and a reference light beam. The signal light beam is directed onto at least one point on a surface of an object and diffusely reflecting the signal light beam as a feedback light beam. The feedback light beam is received and the feedback light beam directed along a first path to an optical signal detector. The reference light beam is transmitted along a second path onto the optical signal detector.

According to yet another aspect of the disclosure a laser radar projection system is provided. The laser radar projection system including a laser projector that projects a light beam. A beam splitter is arranged to receive the light beam from the laser projector, wherein in operation the beam splitter divides the light beam into a signal light beam and a first reference light beam. An optical modulator is arranged to receive the first signal light beam and operable to bifurcate the first signal light beam into a zero-order light beam and a first-order light beam, the optical modulator being controlled by an input voltage. An attenuator is arranged to receive the first reference light beam and output a second reference beam, the second reference beam having a reference optical power level that is less than an optical power of the first reference beam. A steering system is provided that in operation changes the direction of the first order light beam onto the surface of an object and in operation scan the light beam over at least a portion of the surface, wherein the projected light beam is diffusely reflected from the surface as a feedback light beam. An optical signal detector is arranged to receive the feedback light beam and the reference light beam, the optical signal detector generating in operation a feedback signal in response to receiving the feedback light beam and a reference signal in response to receiving the reference light beam. One or more processors are provided that are responsive to executable computer instructions for determining the distance to one or more points on the at least a portion of the surface based at least in part on the feedback signal and the reference signal. The one or more processors are further responsive to applying a synchronized periodic waveform control signal to the input voltage to change the intensity of the first-order light beam.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a schematic illustration of a laser radar projector system in accordance with an embodiment of the invention;

FIG. 2 is a side view of a projected laser beam from the system of FIG. 1 striking a surface of a work piece in accordance with an embodiment;

FIG. 3 is a schematic illustration of the optical detector of the system of FIG. 1 in accordance with an embodiment of the invention;

FIG. 4 is a block diagram of the system of FIG. 1 in accordance with an embodiment of the invention;

FIG. 5 is a diagram illustrating a path of the laser beam emitted from the system of FIG. 1 forming a scan pattern in accordance with an embodiment of the invention;

FIG. 6 is a diagram illustrating another path of the laser beam emitted from the system of FIG. 1 forming a scan pattern in accordance with an embodiment of the invention;

FIGS. 7A-7D illustrate a waveform for controlling an acousto-optical modulator for the system of FIG. 1 in accordance with an embodiment of the invention; and

FIG. 8 is a flow diagram of a method of operating the system of FIG. 1.

The detailed description explains embodiments of the disclosure, together with advantages and features, by way of example with reference to the drawings.

### DETAILED DESCRIPTION

Embodiments of the present invention provide for a laser radar projector having a feedback beam of light and a reference beam of light measured by a single optical sensor. Further embodiments of the present invention provide for a laser radar projector wherein an optical power level of a reference light beam is reduced to have an optical power level at the optical sensor that is substantially equal to the optical power level of the feedback light beam.

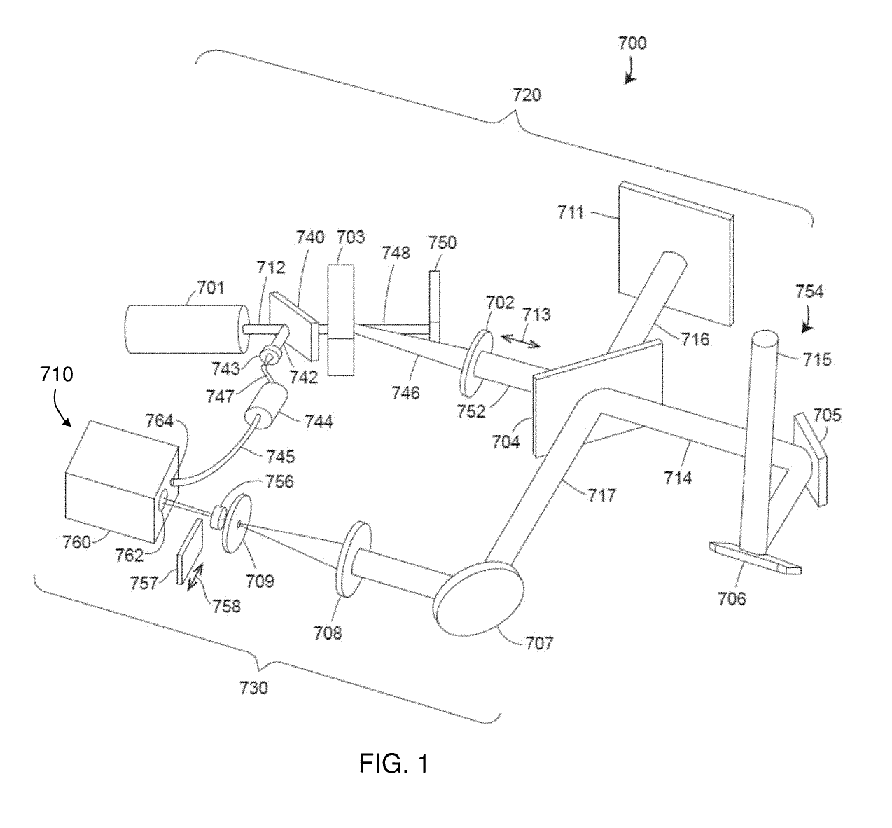

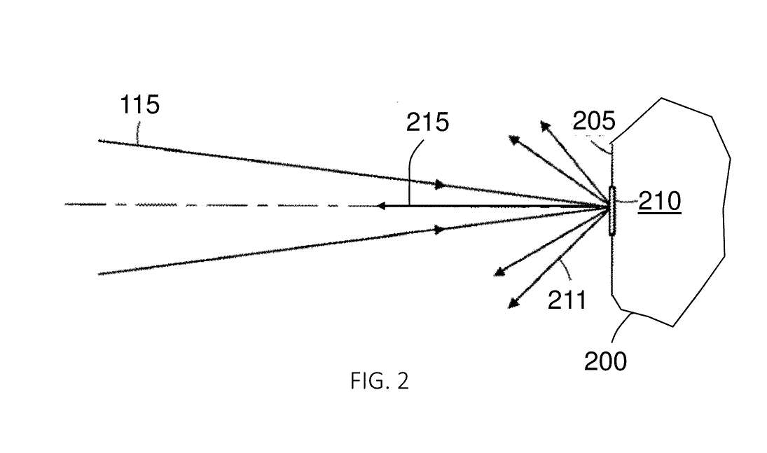

Referring now to FIG. 1, an embodiment is shown of a laser radar projector system 700. The system 700 emits a light beam onto a surface of an object in the environments. As discussed herein, in some embodiments, the light beam is traced over a predetermined path at a rapid rate to generate a template or a light pattern on the surface 205 (FIG. 2) of object 200. The system 700 is also operable to measure the distance from the system 700 to the surface 205 of object 200 and determine the three-dimensional coordinates of points on the surface 205. The laser radar projector system 700 includes a projection subsystem 720 and a feedback subsystem 730. The projection subsystem 720 includes a light source 701, such as a laser light source that is operable to emit pulses of laser light at a rate of 50 kHz to 100 kHz. The light of laser source 701 is used in both functions of the system 700: laser projection and non-contact 3D measurement by scanning and ranging. In an embodiment, the light source 701 emits a light 712 at a green wavelength of 532 nanometers and has a pulse duration of about 250-500 picoseconds. The light beam 712 emitted from laser 701 may have a diameter of about 0.4 to 1.0 millimeters. In an embodiment, the average output power of the laser 701 is about 25 to 30 milliwatts that is adequate, after power losses in the system, to provide the average power of the output beam 715 up to 5 milliwatts. Output laser beam average power of the system 700 within 5 milliwatts corresponds to the Laser Safety Class 3R according to the International Standard IEC 60825-1. In another embodiment, the system 700 could have an output average beam power within 1 milliwatt that corresponds to the Laser Safety Class 3R of International Standard IEC 60825-1.

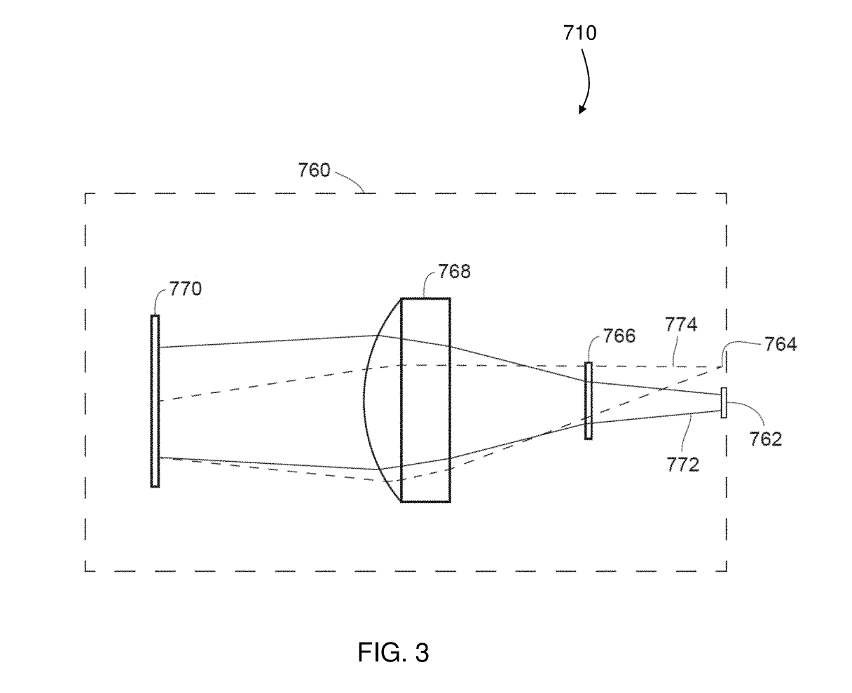

The light source 701 emits a pulsed light beam 712 that strikes a beam splitter 740. The beam splitter 740 reflects a reference light portion 742 of the light beam 712 towards an attenuator 744. In an embodiment, some of the light 742 reflected by the beam splitter 740 passes through a lens 743 that focuses the light into the optical fiber 747. In the exemplary embodiment, the beam splitter 740 reflects about 1% of the light 712 towards the attenuator 744. In the exemplary embodiment, the beam splitter may be a Beam Sampler manufactured by THORLABS, INC. of Newton, N.J. The optical fiber 747 is preferably a single mode type of fiber. A single mode fiber, for example, for a green light, has the fiber core about 4 micrometers in diameter. The light from the fiber 747 travels through the attenuator 744, through an output fiber 745 and is launched into the detector body 760 via an opening 764. In the exemplary embodiment, the attenuator 744 is a variable micro-electromechanical-system (MEMS) such as that manufactured by DICON FIBEROPTICS, INC. of Richmond, Calif. for example. It should be appreciated that other types of optical attenuators may also be used provided that they allow to reduce the optical power of the reference light 742, these attenuators include but are not limited to different kind of variable attenuators, such as loopback attenuators, liquid crystal variable attenuators, electro-optical and acousto-optical attenuators and alike. As will be discussed in more detail herein, the attenuator 744 changes the optical power of the reference light 742 to be similar or substantially equal to the optical power of the feedback light beam that is reflected from the surface 205. This provides advantages in maintaining a similar dynamic range of signals at the optical sensor 710 between the reference light beam and the feedback light beam. As will be discussed in more detail herein, the output of the attenuator 744 is a fiber optic cable 745 that routes the reference light beam to an opening 764 in the detector body that allows the light to strike an optical sensor 770 (FIG. 3).

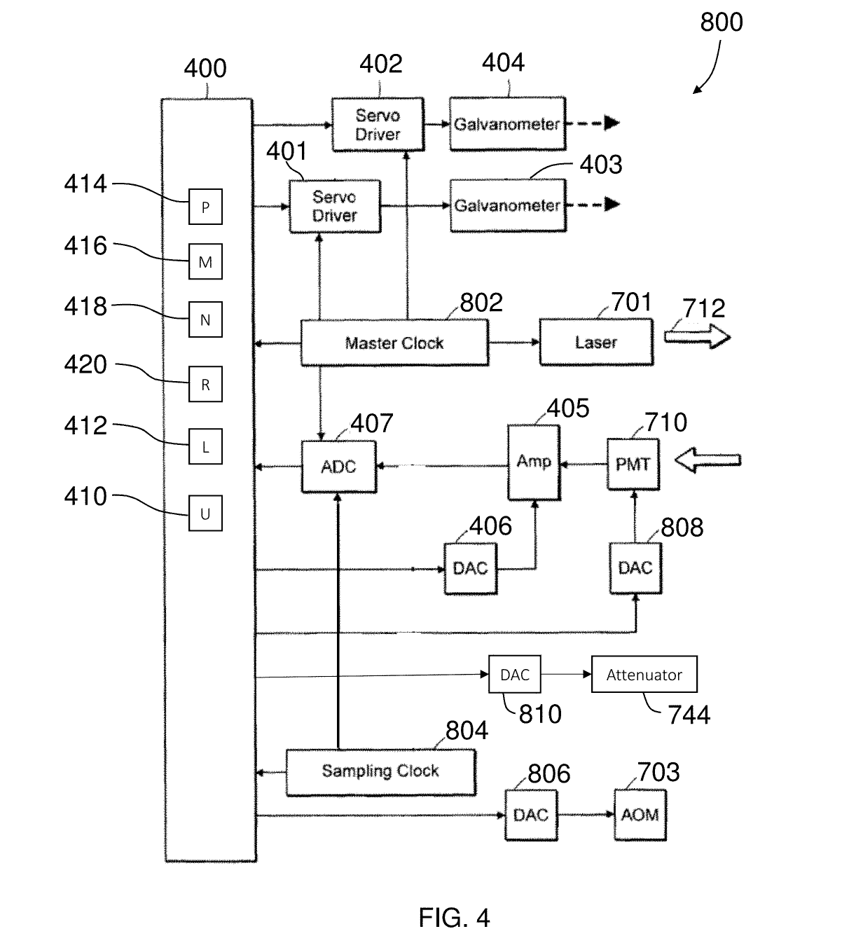

The light that passes through the beam splitter 740 is directed toward an acousto-optical modulator (AOM) 703. The AOM 703 serves as a beam shutter and attenuator thus adjusting the power of the output beam 715 directed toward the object 200. In an embodiment, the AOM 703 works similar to that described by Xu, Jieping and Stroud, Robert, Acousto-optic Devices: principles, design and applications, John Willey & Sons, Inc., 1992, the contents of which are incorporated by reference herein. In the preferred embodiment, the AOM 703 is an AO Frequency Shifter Model 1205-1118 manufactured by ISOMET CORP. of Springfield, Va. USA. The AOM 703 splits the incoming laser light beam into a first order beam 746 and a zero-order beam 748. The intensity or optical power of the first order beam 746 depends on a control signal transmitted from the controller 400 (FIG. 4) to the AOM 703. Depending on a control signal, part of the incoming light is redirected from zero-order 748 to the first order 746. Therefore, the intensity of the first order beam 746 may be varied based on the control signal. In an embodiment, the zero-order beam 748 is directed into a plate 750. In an embodiment, when no control signal is provided to the AOM 703, substantially all of the incoming light beam is being blocked by the plate 750.

The first order beam 746 further passes through a beam expander/collimator 702 which outputs a light beam 752. The beam expander 702 typically consists of two lenses (not shown in FIG. 1) collimating the beam 746 and expanding its diameter about 10 to 15 times. The output lens of the beam expander 702 may be moved in the directions indicated by arrow 713 to allow adjustment of the size and convergence of the beam 752 (and, therefore, the beam 715) thus focusing the output beam 715 as a cone of light 115 (FIG. 2) into a focused laser spot 210 on the surface 205 of the object 200. In an embodiment, the beam expander 702 is coupled to a motor (not shown). This allows the signal light beam 715 to be focused onto a desired focusing point as a cone 115. The light beam 752 that is coming out of the beam expander 702 is directed toward the beam splitter 704. The beam splitter 704 reflects a portion of the light beam 752 as light beam 716. The light beam 716 strikes a beam dump 711 and it dissipated. The remainder of the light beam 752 passes through the beam splitter and proceeds as signal light beam 714. The signal light beam 714 proceeds to steering system 754. The steering system 754 directs the signal light beam 715 from the system 700 towards the object 200. In the exemplary embodiment, the steering system 754 includes a first mirror 705 and a second mirror 706. As discussed in more detail herein, the mirrors 705, 706 each are coupled to a galvanometer 403, 404 (FIG. 4) that allows the selective changing of the angle of the mirror relative to the incoming light beam to allow the changing of the direction of the signal light beam 715. It should be appreciated that the use of mirrors with galvanometers is for exemplary purposes and the claims should not be so limited. In other embodiments, the steering system 754 may include a rotating mirror that rotates about an axis that is substantially collinear with the optical axis of the light beam 714. In still other embodiments, the steering system 754 includes a gimbal arrangement that is rotatable about a pair of orthogonal axes. In this arrangement, the signal light beam 715 may be emitted directly from the beam splitter 704. In yet another embodiment the beam steering system may be based on electro-optical phase array.

In operation the signal light beam 715 is emitted from the system 700 converges into a cone 115 and strikes the surface 205 on the object 200. In this embodiment, the signal light beam 715 is focused on a spot 210. Typically, the surface 205 reflects the light diffusely, and the reflected light 211 is directed widely back towards the system 700. It should be appreciated that a portion of this reflected light 211, referred to herein as the feedback light beam 215, is directed back towards the system 700. In the embodiment of FIG. 1, the feedback light beam enters the system 700 via the mirrors 706, 705 and into the optical feedback subsystem 730. The feedback light beam is transmitted towards the beam splitter 704 along the same optical path as light beam 714. The feedback light beam is reflected off of the beam splitter 704 as light beam 717 towards mirror 707 which decouples the feedback light beam from the shared path with light beam 714. The light beam 717 further passes through a focusing lens 708 and spatial filter 709. The feedback light beam 717 then passes through a beam size lens 756 before passing through an opening 762 in the detector body 760 and striking the optical sensor 710. In an embodiment, the optical sensor 710 is a photomultiplier tube or a hybrid photo detector such as Model R10467U-40 or Model R11322U-40 high speed compact hybrid photo detector manufactured by HAMAMATSU PHOTONICS K.K. of Iwata City, Japan. In an embodiment, a neutral density filter 757 is movable in the direction 758 into or out of the optical path of feedback light beam between the beam size lens 756 and the opening 762. In an embodiment, insertion of the neutral density filter 757 into the optical path based on the brightness of the feedback light beam.

In an embodiment, the lens 708, spatial filter 709 and beam dump 711 cooperate to suppress undesired background light. In an embodiment, the background light suppression may be accomplished in the manner described in co-owned U.S. Pat. No. 8,582,087, the contents of which is incorporated herein by reference. In an embodiment, the spatial filter 709 contains centrally located pinhole formed in a disk-shaped mask as described in the above reference '087 patent. Since the background light that goes through the lens 708 is not collimated it is not concentrated on the pinhole but rather over an area of the mask. The arrangement of the pinhole and the mask thus substantially blocks the undesired background light from striking the optical sensor 710.

In an embodiment, the output of fiber optical cable 745 emits the reference light beam 774 towards the diffuser 766 as shown in FIG. 3. The diffuser 766 diffuses the incoming light and has been found, in combination with the imaging lens 768, to reduce speckle on the optical sensor effective area 770. It should be appreciated that since the reference light beam 774 is on an angle relative to the surface of diffuser 766 (and the optical axis of feedback light beam 772), the diffuser 766 and lens 768 redirect the reference light beam 774 to allow the reference light beam 774 to strike the optical sensor effective area 770. Thus, the reference light beam 774 and feedback light beam 772 both strike the same effective area 770 of the detector 710. This provides advantages in reducing or eliminating signal errors that occurred in prior art systems that utilized separate and discrete optical sensors for the reference and feedback light beams. The system 700 uses time-of-flight principles to determine the distance to the object 200 based on the time difference between the reference light beam pulse and the feedback light beam pulse striking the optical sensor.

Referring now to FIG. 4, an embodiment is shown of the control and signal processing electronics block diagram 800 for the system 700. In an embodiment, the signal light beam 715 is directed towards the object 200 by a pair of orthogonal mirrors 705, 706. The mirrors 705, 706 are mounted on shafts of galvanometers 403, 404. The galvanometers include servo motors containing angular position sensors. In an embodiment, the galvanometers may by a type of Model GM1010 manufactured by CANON U.S.A. of Melville, N.Y. The galvanometer 403 rotates the mirror 705 to steer the light beam 714 in a first plane, such as the horizontal or azimuth plane for example. The azimuth beam steering angle is referenced in the description below as H. Galvanometer 404 rotates the mirror 706 to steer the light beam 715 in a second plane, such as the vertical or elevation plane. In an embodiment, the first plane and the second plane are substantially orthogonal. The elevation beam steering angle is referenced in the description below as V. The mirrors 705, 706 cooperate in a coordinated manner to project the light beam 715 toward a desired point on the object 200 that is within the angular range of the galvanometers 403, 404 with mirrors 705, 706. In an embodiment, the mirrors 705, 706 operate within a range of angles H, V of +/−30°. The galvanometers 403, 404 are activated by servo drivers 401, 402 respectively. In an embodiment, each servo driver has an input interface to receive command signals from a controller 400.

The connection between the controller 400 and the components of the system 700 may be a wired-connection/data-transmission-media or a wireless connection. The controller 400 is a suitable electronic device capable of accepting data and instructions, executing the instructions to process the data, and presenting the results. Controller 400 may accept instructions through user interface 410, or through other means such as but not limited to electronic data card, voice activation means, manually-operable selection and control means, radiated wavelength and electronic or electrical transfer.

Controller 400 uses signals act as input to various processes for controlling the system 700. The digital signals represent one or more system 700 data including but not limited to signals from optical sensor 710, operator inputs via user interface 410 and the like.

Controller 400 is operably coupled with one or more components of system 700 by data transmission media. Data transmission media includes, but is not limited to, twisted pair wiring, coaxial cable, and fiber optic cable. Data transmission media also includes, but is not limited to, wireless, radio and infrared signal transmission systems. Controller 400 is configured to provide operating signals to these components and to receive data from these components via the data transmission media.

In general, controller 400 accepts data from optical sensor 710, and is given certain instructions for the purpose of determining the distance and direction to the object 200 and 3D coordinates of points on surfaces being scanned. The controller 400 may compare the operational parameters to predetermined variances and if the predetermined variance is exceeded, generates a signal that may be used to indicate an alarm to an operator or to a remote computer via a network. Additionally, the signal may initiate other control methods that adapt the operation of the system 700 such as changing the operational state of laser light source 701, the position of galvanometers 403, 404, the setting of AOM 703, the position of neutral density filter 757, and the gain of optical sensor 710 to compensate for the out of variance operating parameter.

The data received from optical sensor 710 may be displayed on a user interface 410. The user interface 410 may be an LED (light-emitting diode) display, an LCD (liquid-crystal diode) display, a touch-screen display or the like. A keypad may also be coupled to the user interface for providing data input to controller 400. In an embodiment, the controller 400 displays in the user interface 410 a point cloud to visually represent the acquired 3D coordinates.

In addition to being coupled to one or more components within system 700, controller 400 may also be coupled to external computer networks such as a local area network (LAN) and the Internet via a communications interface 412. A LAN interconnects one or more remote computers, which are configured to communicate with controller 400 using a well- known computer communications protocol such as TCP/IP (Transmission Control Protocol/Internet Protocol), RS-232, ModBus, and the like. Additional systems 700 may also be connected to LAN with the controller 400 in each of these systems 700 being configured to send and receive data to and from remote computers and other systems 700. The LAN is connected to the Internet. This connection allows controller 400 to communicate with one or more remote computers connected to the Internet.

Controller 400 includes a processor 414 coupled to a random-access memory (RAM) device 416, a non-volatile memory (NVM) device 418, a read-only memory (ROM) device 420, one or more input/output (I/O) controllers, and a communications interface device 412.

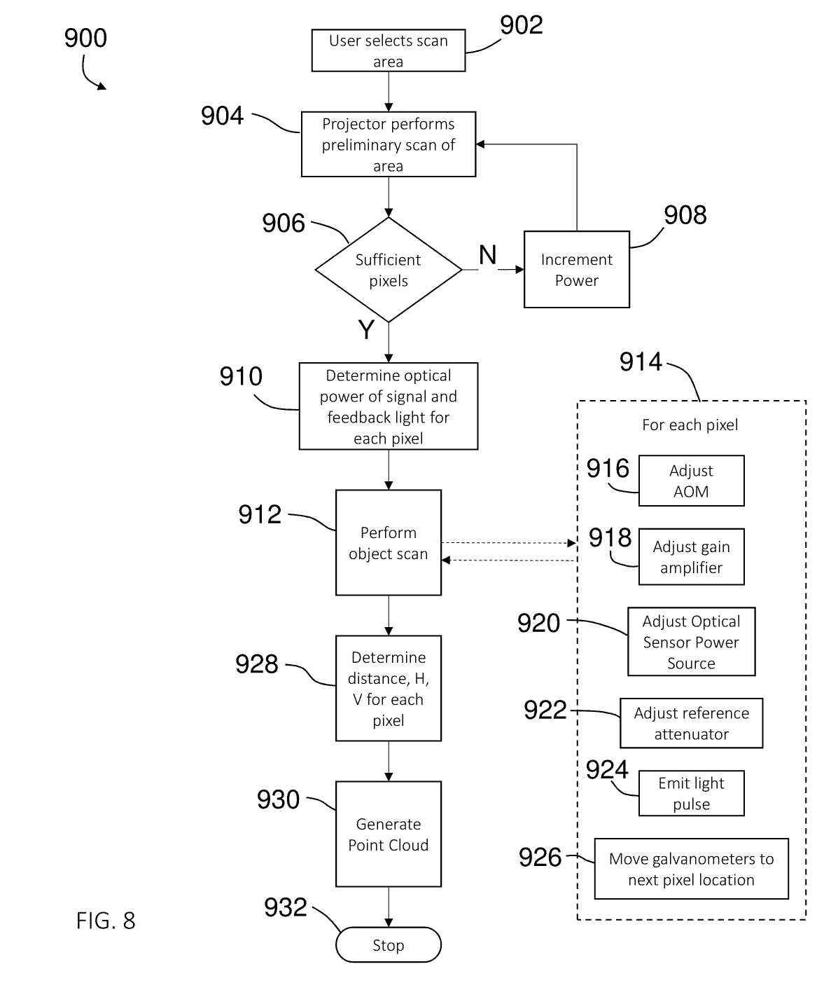

Communications interface 412 provides for communication between controller 400 and a network in a data communications protocol supported by the network. ROM device 420 stores an application code, e.g., main functionality firmware, including initializing parameters, and boot code, for processor 414. Application code also includes program instructions as shown in FIG. 8 for causing processor 414 to execute any system 700 operation control methods, including starting and stopping operation, changing operational states of the laser light source 701, galvanometers 403, 404 and optical sensor 710, monitoring predetermined operating parameters, and generation of alarms. In an embodiment, the application code creates an onboard telemetry system may be used to transmit operating information between the system 700 and one or more remote computers or receiving locations. The information to be exchanged remote computers and the controller 400 include but are not limited to computer-aided-design (CAD) data and 3D coordinate data.

NVM device 418 is any form of non-volatile memory such as an EPROM (Erasable Programmable Read Only Memory) chip, a disk drive, or the like. Stored in NVM device 418 are various operational parameters for the application code. The various operational parameters can be input to NVM device 418 either locally, using a user interface 410 or remote computer, or remotely via the Internet using a remote computer. It will be recognized that application code can be stored in NVM device 418 rather than ROM device 420.

Controller 400 includes operation control methods embodied in application code such as that shown in FIG. 8. These methods are embodied in computer instructions written to be executed by processor 414, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, Visual C++, C#, Objective-C, Java, Javascript ALGOL (algorithmic language), BASIC (beginners all-purpose symbolic instruction code), visual BASIC, ActiveX, HTML (HyperText Markup Language), Python, Ruby and any combination or derivative of at least one of the foregoing. Additionally, an operator can use an existing software application such as a spreadsheet or database and correlate various cells with the variables enumerated in the algorithms. Furthermore, the software can be independent of other software or dependent upon other software, such as in the form of integrated software.

As will be discussed in more detail herein, the controller 400 may be configured to determine three-dimensional coordinate data for one or more points located on the surface 205 of object 200.

In an embodiment, the controller 400 further includes an energy source. In an embodiment, the energy source may be a battery that is an electrochemical device that provides electrical power for the controller 400. In an embodiment, the battery may also provide electrical power to the light source 701, optical sensor 710 and galvanometers 403, 404. In some embodiments, the battery may be separate from the controller (e.g. a battery pack). In an embodiment, a second battery may provide electrical power to the light source 701, optical sensor 710 and galvanometers 403, 404. In still further embodiments, the light source 701 may have a separate energy source (e.g. a battery pack).

It should be appreciated that the controller 400 may be arranged in a housing (not shown) with the light source 701, optical sensor 710 and galvanometers 403, 404, or may be spaced apart (separate). Further, while embodiments herein illustrate the controller 400 as being coupled with a system 700, this is for exemplary purposes and the claims should not be so limited. In other embodiments, the controller 400 may be coupled to and combine three-dimensional coordinate data from multiple systems 700.

In operation, the controller 400 causes the light source 701 to generate light pulses which are triggered by a master clock 802. In the exemplary embodiment, the light pulses are generated at a frequency of about 100 kHz. The controller 400 generates a scan pattern and trajectory for the signal light beam as a series of beam steering commands that are transmitted to the servo-drivers 401, 402. In an embodiment, the beam steering commands are transmitted at equal time increments as defined by the master clock 802. The master clock 802 synchronizes the stream of position commands to the galvanometer servo drivers 401, 402 during both modes of operation, namely projection scan and object scan. In the projection operation, the AOM 703 is controlled in an on/off mode of operation by controller 400. This allows the system 700 to generate piece-wise trajectories thus creating glowing templates (when the light beam 715 is in the visible spectrum) by repeating the same trajectory at a high rate on the surface 205 of the object 200. If the repetition rate is more than 25-30 Hz than the user perceives the glowing template as a steady image. In the object scan operation, the system 700 generates a raster scan pattern, and collects the light feedback signal by the subsystem 730. A raster scan pattern, such as that shown with respect to FIG. 6, will be discussed in more detail in the description below. In the object scan mode, the system 700 processes the feedback signals and derives a three-dimensional point cloud of the object. As used herein, a point cloud is a collection or a set of data points in a coordinate system. In a three-dimensional coordinate system, these points are usually defined by X, Y, and Z coordinates, and represent the digitized surface of an object 200 that is scanned with the system 700.

In an embodiment, the electrical signal obtained from the optical sensor 710 during raster scan of the object 200 is amplified by amplifier 405 and transmitted to the ADC 407 to digitize this analog signal. The electrical analog output signal of the sensor 710 is generated in response to the striking of the effective area 770 of the optical sensor 710 by the reference light pulse in the beam 764 or the feedback light pulse in the beam 717. The ADC 407 is controlled by a sampling clock 804. In an embodiment, the sampling rate is about 10 billion samples per second (10 Gigasamples per second) and the resolution of the ADC 407 is 10 bits. It should be appreciated that due to the distance travelled by the light beam 715 to the object 200 and back, the reference light pulse in the beam 764 will strike the optical sensor 710 before the feedback light pulse in the beam 717. The optical sensor 710 generates an electrical reference pulse signal when the reference light pulse in the beam 764 strikes the optical sensor 710 and an electrical feedback pulse signal when the feedback light pulse in the beam 717 strikes the optical sensor 710. Thus, determining the time difference between the reference pulse signal and the feedback pulse signal allows the determination of the distance to the point 210 on the object 200 using time-of-flight principles and knowing the speed of light in air.

For a distance of 100 feet, the delay between the reference pulse signal and the feedback pulse signal is about 200 nanoseconds or less. When the system 700 is operated to generate light pulses at a rate of 100 kHz, the time period between a first pair of pulse signals and the following pair of pulse signals is about 10 microseconds.

The output of ADC 407 is connected to the controller 400 that processes the signals to determine the pulse amplitude for the object feedback signal that corresponds to the feedback light intensity, and the time delay between the feedback signal pulse and the reference signal pulse. Each signal pulse is represented in memory 416 as a sampled and recorded waveform of the electrical signal digitized by the ADC 407. In an embodiment, the feedback signal pulse amplitude values (e.g. the peak values of the recorded waveform) are utilized to construct a pixelized intensity image during raster scan of the object 200 as discussed in more detail in the description below.

It should be appreciated that the object 200 may have a variety of surface conditions, such as different surface reflectivity for example. The object may have shiny metal surfaces, retroreflective targets and black carbon-fiber materials. Further, the intensity of the light received by the optical sensor 710 varies reciprocally to the squared distance between the system 700 and the point on the surface 210. It has been found that in a typical scanning application, the dynamic range of the reflectivity variations may be about of 100,000, and, sometimes, may be as large as 500,000.

Due to this large variation in reflectivity, the controller 400 may reduce intensity of the outgoing light pulse so that the feedback light intensity from shiny surfaces (e.g. highly reflective) is brought to values within an acceptable signal range for the sensor 710 and the ADC 407. To change the intensity/optical-power of the outgoing light beam 715, the controller 400 transmits a command signal to DAC 806. The DAC 806 controls the voltage applied to the AOM 703 to vary intensity of the first order beam 746 transmitted by the AOM 703.

In one embodiment, the AOM 703 is controlled to improve system 700 stability and accuracy. According to its principal of operation described in the aforementioned publication “Acousto-optic Devices: principles, design and applications”, a typical acousto-optical modulator changes the intensity of the beam 746 (transmitted through it as a first diffraction order) following variation of the AOM's internal ultrasound acoustic power. Typically, the ultrasound acoustic power is being applied to the AOM crystal via an internal transducer driven by a sinusoidal electrical signal in a radio frequency (RF) range. In an embodiment, the RF power applied to the AOM ultrasound transducer is proportional to the control signal voltage applied to the internal RF power driver (not shown) of the AOM 703 from the DAC 806. In an embodiment, the output voltage of DAC 806 is changing between 0 and 1 Volts. The higher this voltage the more intensity of the first order beam 713 is transmitted through the AOM 703. However, if the AOM is controlled by an arbitrary variable DC voltage it can unpredictably change direction of its output beam 746 thus introducing errors in scanning and in determining point cloud coordinates X, Y, Z. The source of beam directional errors is in the arbitrary RF power heat dissipation inside the AOM crystal originated from the arbitrary variable DC voltage control needed for AOM usage as the beam shutter and/or attenuator in projection and scanning modes of operation. It has been found that variable RF power heat dissipation inside the AOM crystal leads to beam directional errors because it causes variations of the ultrasound wave periodicity that changes the diffraction angle for the first order beam 746.

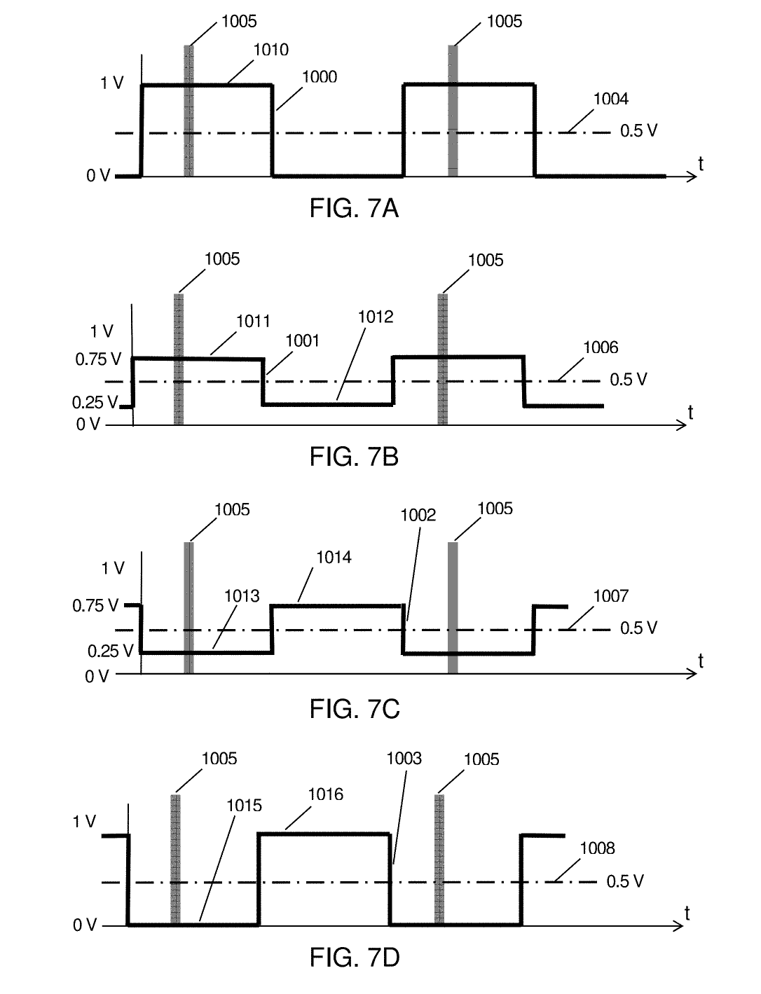

In an embodiment, the elimination of beam directional errors is is performed by applying a synchronized periodic square waveform control signal from the output of the DAC 806 to the AOM module 703. In an embodiment, the magnitude of the control signal is symmetrically variable within the range, for example, from 0 to 1 volts while the average level of the control signal is equal to the half of the maximum voltage control, e.g. 0.5 volts in the exemplary embodiment. The frequency and the phase of the square waveform control signal are synchronized with the laser light pulses as it shown in FIGS. 7A-7D. The level of the control signal 1000, 1001, 1002, 1003 during each half of the period without laser pulse 1005 always complements the level of the control signal during every half of the period with laser pulse. As the result, the RF power heat dissipation inside the AOM crystal stays constant at the level corresponding to the average level of the control voltage 0.5 volts regardless of the arbitrary varying output beam intensity by varying magnitude of the square waveform control signal. Consequently, the AOM crystal will be at a thermal equilibrium at all times, and an undesired directional wander of the output beam 746 will be reduced or eliminated.

As shown in FIGS. 7A, the control signal 1000 drives the AOM 703 fully opened (e.g. maximum intensity of the light beam 746) because the control signal level 1010 is equal 1 volt at every half of the period when the laser pulse 1005 appears. The average level 1004 of the control signal 1000 is equal to the half of its maximum, e.g. 0.5 volts. Another embodiment, shown in FIG. 7B shows the control signal 1001 with such a magnitude that the AOM transmission is reduced to about three quarters of the maximum because the control signal level 1011 is equal 0.75 volt at every half of period when the laser pulse 1005 appears. The average level 1006 of the control signal 1001 stays at 0.5 volts because the level 1012 of the signal 1001 at every half of period without laser pulse is equal 0.25 volts, e.g. complementing the level 1011 symmetrically around the level 1006. Similarly, in another embodiment shown in FIG. 7C, the magnitude of the control signal 1002 reduces the AOM transmission to about a quarter of the maximum because the control signal level 1013 is equal 0.25 volt at every half of period when the laser pulse 1005 appears. The average level 1007 of the control signal 1002 stays at 0.5 volts because the level 1014 of the signal 1002 at every half of period without laser pulse is equal 0.75 volts, e.g. complementing the level 1013 symmetrically around the level 1007. In yet another embodiment shown in FIG. 7D, control signal 1003 causes the AOM 703 to be fully closed (no transmission of the first order light beam 746) because the control signal level 1015 is equal 0 volts at every half of the period when the laser pulse 1005 appears. The average level 1008 of the control signal 1003 stays at 0.5 volts because the level 1016 of the signal 1003 at every half of period without laser pulse is equal 1 volt, e.g. complementing the level 1015 symmetrically around the average level 1008. It should be appreciated that, in this way of operation, the average level of the AOM control signal stays exactly at the same value equal to the half of the maximum control voltage (1 volt in this exemplary embodiment) regardless of an arbitrary varying the control signal level required for a given transmission of the AOM 703.

It should be appreciated that while embodiments described herein refer to a particular voltage or waveform, this is for exemplary purposes and the claims should not be so limited. In other embodiments, other voltages or waveforms may be used.

Further, in an embodiment the variable gain amplifier 405 may be controlled by the DAC 406 to mitigate variations in signal strength. The dynamic range of the amplifier 405 is typically between 10-20. Finally, the gain of the optical sensor 710 may be adjusted by changing its power source voltage through DAC 808. By combining the signal strength adjustment capabilities of the AOM 703, the amplifier 405, the neutral density filter 757, and the optical sensor 710, a dynamic range of 500,000 or greater may be achieved.

It should be appreciated that while the beam splitter 740 diverts less than 1% of the light beam 712 for use as a reference light beam, the optical power of this reference light beam, without variable attenuation, would be constant and, in many cases, would substantially exceed in many times that of the optical power of the feedback light beam 717 that varies. The variations and losses in optical power of the feedback light beam 717 may be due to surface conditions, distance and diffusion upon striking the surface 205. It should further be appreciated that it is desirable to have the optical power of the reference light beam 764 to be adjustable to become about the same as that of the feedback light beam 717. This allows to substantially narrow the required dynamic signal range of the sensor 710 and the ADC 407. To accomplish this, the controller 400 transmits a command signal to the DAC 810 that controls the variable attenuator 744. Typically, the weaker the signal from the feedback beam 717, the deeper attenuation is by the variable attenuator 744 to equalize the feedback signal and the reference signal, and the higher the gain that is needed for the sensor 710 and the amplifier 405 to process them together.

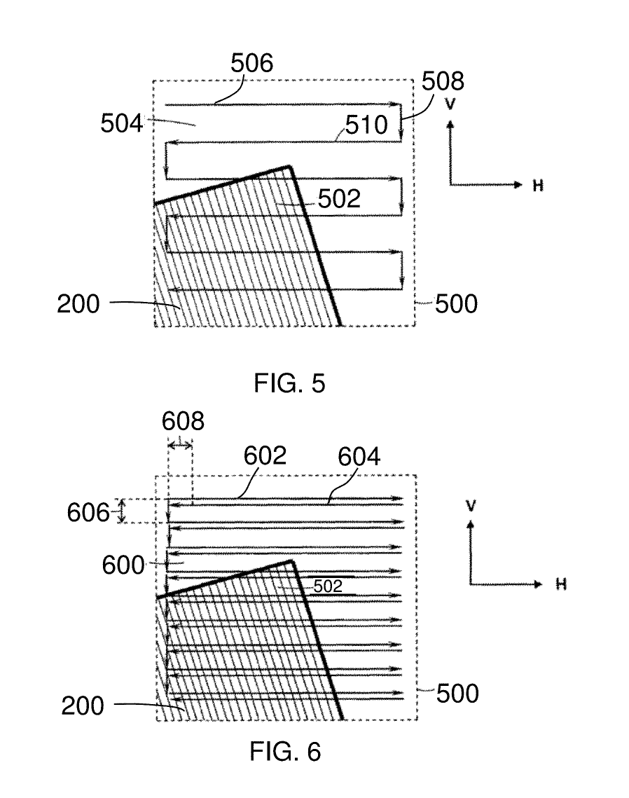

Typically, a preliminary object scan is performed to evaluate a signal strength of the feedback beam 717 and to establish proper gain control levels for the amplifier 405, sensor 710, and AOM 703 through their DACs 406, 808, and 806, as well as attenuation control level for the variable attenuator 744 through its DAC 810. In an embodiment shown in FIG. 5, the system 700 performs an initial scan of an area 500 around a part 502 of the surface 205 of object 200. The controls for sensor 710, amplifier 405, AOM 703, and attenuator 744 are set to their initial values. The light beam 715 is steered via galvanometers 403, 404 and mirrors 705, 706 at a constant velocity and varying azimuth angle H along a pattern 504. The pattern 504 begins along trace line 506. At the end of line 506, the galvanometer 403 stops and the galvanometer 404 steers the beam to vary the elevation of the signal light beam 715 along line 508. The galvanometer 404 then stops and the galvanometer 403 steers the signal light beam 715 along retrace line 510. This scan process continues in this bi-directional manner to cover the area 500. It should be appreciated that during each trace and retrace, the galvanometer 403 is driven by a stream of digital command signals from controller 400 via servo driver 401. In an embodiment, the command signals are transmitted at substantially equal time increments as defined by the master clock 802. At each time increment, controller 400 processes the output of ADC 407 to determine the pulse amplitude for the object feedback signal that corresponds to the feedback light intensity. In an embodiment, the controller 400 constructs a two-dimensional image array comprised of a series of rows. Each row representing a digitized signal intensity along the trace or retrace line.

In an embodiment, after the completion of the preliminary scan, the controller 400 analyzes a captured digital image (based at least in part of the image array) and determines the high or maximum value of the image array. That value corresponds to a large or maximum amplitude of the amplified feedback signal pulses. Based on the result, the controller 400 may determine adequate levels of controls for sensor 710, amplifier 405, AOM 703, and attenuator 744 that could be used for the next detailed object scan to keep the pulse signals amplitudes within an acceptable signal range for the sensor 710 and the ADC 407. It should be appreciated that multiple successive preliminary scans could be performed to establish proper levels of controls for sensor 710, amplifier 405, AOM 703, and attenuator 744.

The detailed object scan that is being performed after one or more preliminary scans is illustrated in FIG. 6. It shows a scan trajectory that follows a bi-directional scan pattern 600. In contrast to the preliminary scan, in an embodiment, the final scan includes a trace 602 and a retrace 604 that are superimposed or collinear. It should be appreciated that lines 602, 604 are illustrated slightly separated in FIG. 6 for clarity purposes only. The controller 400 then proceeds to perform the scan line by line, as described herein with respect to the preliminary scan, with the trace and retrace lines being separated by a vertical segment 606. In an embodiment, the trace and retrace line segment 606 (V pixel size) and the sampling interval 608 (H pixel size) are each typically between 30 to 50 micro radians. In an embodiment, the resolution is user definable.

In an embodiment, an array of pixel data is being constructed by the controller 400 as the result of the detailed object scan. Each element of the array is associated with the H and V pixel locations and contains the values of the feedback light intensity and the time-of-flight represented as the time delay between the reference signal pulse and the feedback signal pulse. The light intensity values are utilized to construct a pixelized two-dimensional intensity image for object feature detection. This feature detection may be the same as that described in the aforementioned U.S. Pat. No. 8,582,087. The time-of-flight represented as the time delay is used to calculate the distance between the system 700 and the pixel point by multiplying the value of time delay by the speed of light in air. The time delay is determined as being the difference between the timing locations of the reference signal waveform and the feedback signal waveform with respect to the train of sampling pulses generated by sampling clock 804. An exemplary method of extracting the timing location of the pulse waveform independently from the pulse's amplitude is described in Merrill Scolnik, “Introduction to Radar Systems”, McGraw-Hill, International Editions, 2002, the contents of which are incorporated herein by reference.

As the distance to each pixel point is determined during the detailed object scan, the controller 400 derives the X, Y, Z coordinates of this point based on its distance and the H and V values in a projector coordinate frame of reference (sometimes referred to as galvanometer space). Controller 400 further displays a three-dimensional point cloud array X, Y, Z on the user interface 410 as representation the digitized surface 205 of the object 200. It should be appreciated that the point cloud data may be also sent to an external computer network via communications interface 412.

Referring now to FIG. 8, a method 900 is shown for operating the system 700. The method 900 starts with block 902 where the user selects a scan area containing the object 200, such as area 500 (FIG. 5) for example. The method 900 then proceeds to block 904 where the laser radar projection system 700 performs a preliminary scan, such as using the raster scan pattern 504 for example, within the scan area. This preliminary scan is performed to ensure that valid signals are obtained from the scan pixels. As discussed herein the feedback signal may vary based on a variety of factors, such as but not limited to surface conditions and distance to the object for example. In the exemplary embodiment, the preliminary scan is an iterative process having a sequence of scans performed at different optical power. For the initial scan, the optical power is set to a low or minimum optical power, such as by adjusting the AOM 703 for example. The scan is performed for each trace and retrace of the pattern 504 with the pixels recorded that return a valid feedback signal. In one embodiment, the pixels are valid if the feedback signal strength is within a predetermined range for the ADC 407 for example. The method 900 then proceeds to query block 906 where it is determined whether a sufficient number of valid pixels have been recorded. This may be determined by assigning a pixel density for example. When the query block 906 returns a negative, the method 900 proceeds to block 908 where the optical power is increased, the gain of the optical sensor 710 is increased or a combination thereof. The method 900 then loops back to block 904 and the process is repeated until a desired number of pixels is achieved. When the query block 906 returns a positive, the system 700 has an array of pixel locations and system 700 parameters (e.g. AOM setting, amplifier gain, power source voltage) to achieve a desired feedback signal strength.

The method then proceeds to block 910 where the optical power and feedback light for each pixel are determined. In block 912 the detailed object scan is performed within the selected area. In an embodiment, the detailed object scan follows a raster pattern, such as pattern 500 (FIG. 6) for example. For each pixel location within the pattern 500, the system performs control levels adjustments in block 914, these adjustments may include adjusting 916 the transmission of the AOM 703, adjusting 918 the gain of amplifier 405, adjusting 920 the voltage of power source of optical sensor 710, adjusting 922 the reference attenuator 744, emitting 924 the light pulse 712 from light source 701, and then adjusting 926 the position of the galvanometers 403, 404. The adjustments 916-922 may be based at least in part on the preliminary scan 904 to provide a feedback signal strength that is within a desired range for the optical sensor 710. It should be appreciated that in another embodiment the detailed scan may be an iterative process having a sequence of scans performed at common sets of adjustments 916-922 defined by the controller 400 for the next successive scan based on the results of the previous one. Finally, for each pixel, the distance to the measured point is determined and stored along with the H and V values in block 928.

Once the object scan is completed, the method 900 then proceeds to block 930 where the three-dimensional coordinates X, Y, Z for each pixel are determined based on the distance, H and V values, and the point cloud data array is generated. The method 900 then stops in block 932.

It should be appreciated that while the exemplary embodiments illustrates portions of the light beams being transmitted through free air, this is for exemplary purposes and the claims should not be so limited. In other embodiments, other devices, such as fiber optic devices may be used to transfer the light beams from a first portion of the system to a second portion of the system. Further, components such as fiber optic couplers may be used in place of a beam splitter for example.

It should also be appreciated that while raster scan patterns are described herein, the claims should not be so limited. In other embodiments, other scan patterns may be used.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A laser radar projection system comprising:
a laser projector that projects a light beam;
a beam splitter arranged to receive the light beam from the laser projector, wherein in operation the beam splitter divides the light beam into a signal light beam and a reference light beam;
a steering system that in operation changes the direction of the signal light beam onto the surface of an object and in operation scan the light beam over at least a portion of the surface, wherein the projected light beam is diffusely reflected from the surface as a feedback light beam;
an optical signal detector arranged to receive the feedback light beam and the reference light beam, the optical signal detector generating a feedback signal in response to receiving the feedback light beam and a reference signal in response to receiving the reference light beam; and
one or more processors that are responsive to executable computer instructions for determining the distance to one or more points on the at least a portion of the surface based at least in part on the feedback signal and the reference signal.

2. The system of claim 1, further comprising:
an optical modulator arranged to receive the signal light beam prior to the steering system and operable to bifurcate a zero-order light beam and a second signal light beam from the signal light beam, the optical modulator being controlled by an input voltage;
wherein the one or more processors are further responsive to applying a synchronized periodic waveform control signal to the input voltage to change the intensity of the signal light beam output from the optical modulator.

3. The system of claim 1, further comprising an attenuator member optically disposed between the beam splitter and the optical signal detector, the attenuator member being arranged to receive the reference light beam and in operation changing a reference beam optical power level of the reference light beam.

4. The system of claim 3, wherein:
the feedback beam of light has a feedback beam optical power level at the optical signal detector; and
the attenuator in operation reduces the reference beam optical power level at the optical signal detector to be substantially equal to the feedback beam optical power level.

5. The system of claim 4, wherein the attenuator is micro-electro-mechanical system (MEMS) attenuator.

6. The system of claim 4, wherein the attenuator is selected from a group comprising: fixed attenuators, loopback attenuators, variable attenuators, liquid crystal variable attenuators, lithium niobate attenuators, and variable optic attenuators.

7. The system of claim 3, further comprising a fiber optic cable having a first end and a second end, the first end being optically coupled to the attenuator to receive the feedback light beam, the second end being arranged to direct the feedback light beam onto the optical signal generator.

8. The system of claim 1, wherein:
the optical signal detector includes a housing with a input port;
the reference beam is transmitted along a first path;
the feedback light beam is transmitted along a second path; and
the first path and second path are substantially coincident at the input port.

9. The system of claim 8, wherein the first path and the second path are arranged to direct the feedback light beam and the reference light beam onto a photosensitive member.

10. The system of claim 1, wherein the one or more processors are further responsive to determine three-dimensional coordinates of the one or more points based at least in part on a position of the steering system.

11. A method of determining three-dimensional coordinates of at least one point on a surface of an object, the method comprising:
emitting a beam of light from a laser projector;
dividing the beam of light with a beam splitter into a signal light beam and a reference light beam;
directing the signal light beam onto at least one point on a surface of an object and diffusely reflecting the signal light beam as a feedback light beam;
receiving the feedback light beam and directing the feedback light beam along a first path to an optical signal detector; and
transmitting the reference light beam along a second path onto the optical signal detector.

12. The method of claim 11, further comprising:
bifurcating a zero-order light beam from the signal light beam with an optical modulator, the optical modulator being positioned between the laser projector and the directing of the signal light beam onto the at least one point; and
changing the intensity of the signal light beam output from the optical modulator by applying a synchronized periodic waveform control signal to an input voltage of the optical modulator.

13. The method of claim 11, further comprising attenuating a reference optical power level of the reference light beam prior to directing the reference light beam onto the optical detector.

14. The method of claim 13, wherein the reference optical power level is attenuated to be substantially equal to a feedback optical power level of the feedback light beam at the optical signal detector.

15. The method of claim 14, wherein the second path is at least partially defined by a fiber optic cable coupled to an attenuator.

16. The method of claim 15, wherein the attenuator is a MEMS-type attenuator.

17. The method of claim 11, further comprising:
generating a feedback signal in response to the feedback light beam striking the optical signal detector; and
generating a reference signal in response to the reference light beam striking the optical signal detector.

18. The method of claim 11, further comprising determining a distance to the at least one point based at least in part on the feedback signal and the reference signal.

19. A laser radar projection system comprising:
a laser projector that projects a light beam;
a beam splitter arranged to receive the light beam from the laser projector, wherein in operation the beam splitter divides the light beam into a first signal light beam and a first reference light beam;
an attenuator arranged to receive the first reference light beam and output a second reference beam, the second reference beam having a reference optical power level that is less than an optical power of the first reference beam;
an optical modulator arranged to receive the first signal light beam and operable to bifurcate the first signal light beam into a zero-order light beam and a first-order light beam, the optical modulator being controlled by an input voltage;
a steering system that in operation changes the direction of the signal light beam onto the surface of an object and in operation scan the light beam over at least a portion of the surface, wherein the projected light beam is diffusely reflected from the surface as a feedback light beam;
an optical signal detector arranged to receive the feedback light beam and the reference light beam, the optical signal detector generating in operation a feedback signal in response to receiving the feedback light beam and a reference signal in response to receiving the reference light beam; and
one or more processors that are responsive to executable computer instructions for determining the distance to one or more points on the at least a portion of the surface based at least in part on the feedback signal and the reference signal, wherein the one or more processors are further responsive to applying a synchronized periodic waveform control signal to the input voltage to change the intensity of the first-order light beam.

20. The system of claim 19, wherein:
feedback light beam is transmitted along a first path, a portion of the first path including traveling through free space, to the optical signal detector;
the second reference light beam is transmitted along a second path to the optical signal detector; and
the portion of the first path and the second path are substantially coincident at the optical signal detector.

21. The system of claim 20, wherein:
the attenuator is a MEMS-type attenuator; and
the optical signal detector is a photomultiplier tube.

22. The system of claim 20, wherein the reference optical power level and a feedback optical power level of the feedback light beam are substantially equal adjacent the optical signal detector.

23. The system of claim 19, wherein the synchronized periodic waveform control signal is symmetrically variable within a predetermined range.

24. The system of claim 23, wherein the synchronized periodic waveform control signal provides an average input voltage that is one-half a maximum voltage.
